(19) United States
(12) Patent Application Publication
(10) Pub. No.: US 2017/0364156 A1
(43) Pub. Date: Dec. 21, 2017

(54) GESTURE BASED FEEDBACK FOR WEARABLE DEVICES

(71) Applicant: Intel Corporation, Santa Clara, CA (US)

(72) Inventors: Kahyun Kim, Portland, OR (US); Kristina L. Ortega, Portland, OR (US); Megan E. Hansen, Portland, OR (US); Glen Eric Lewallen, Portland, OR (US)

(21) Appl. No.: 15/188,319

(22) Filed: Jun. 21, 2016

(51) Int. Cl. G06F 3/01; G06F 1/16

(52) U.S. Cl. CPC G06F 3/016; G06F 1/163; G06F 3/017

(57) ABSTRACT

Various systems and methods for providing wearable device feedback based on detected gestures and patterns of the gestures are described herein. A system for providing feedback based on detected gestures and patterns of the gestures includes an accelerometer; a gyrometer; a magnetometer; a gesture detection circuit to: detect a gesture performed by a user of the system based on data from the accelerometer, gyrometer or magnetometer; and determine a pattern of the gesture; a processor subsystem to determine a feedback pattern and a feedback intensity based on the gesture and the pattern of the gesture; and at least one feedback element to provide feedback according to the feedback pattern and the feedback intensity. The at least one feedback element may include LED lights and/or haptic motors.

### TECHNICAL FIELD

Embodiments described herein generally relate to wearable devices and in particular, to providing gesture based feedback for wearable devices.

### BACKGROUND

Wearable electronic devices are produced in shapes such as bands, bracelets, watches, and other form factors that may directly or indirectly attach to a human user. A wearable device may include a variety of specialized circuitry and sensors to detect activity such as a motion, an acceleration, a tilt or an orientation of the human user of the wearable device. Various types of such wearable devices provide feedback to the user via lights, sounds or physical vibrations. These forms of feedback are usually pre-determined (e.g., their intensity, frequency, length etc.) at the software level.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is an example wearable electronic device, according to an embodiment;

FIG. 2 is a block diagram illustrating a gesture based feedback device, according to an embodiment;

FIG. 3 is a use case diagram of an example wearable electronic device upon which one or more embodiments may be implemented:

FIG. 4 is a use case diagram of an example wearable electronic device upon which one or more embodiments may be implemented;

FIG. 5 is a block diagram illustrating system for providing feedback based on detected gestures, according to an embodiment:

FIG. 6 is a flowchart illustrating a method for providing feedback based on detected gestures, according to an embodiment; and

FIG. 7 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Many simple wearable electronic devices (e.g., wrist-worn) use light-emitting diodes (LED) lights to provide a limited visual feedback to communicate with the wearer of the device. For example, a set of LED lights may be used to indicate a count associated with some activity of the wearer of the device. However, this type of light feedback is often pre-determined at the software level and not capable of appropriate variation in response to different user inputs. As a result, users perceive these wearable devices as not sufficiently responsive or interactive to their input actions. In an embodiment described herein, a method is used to recognize a wearable device user's gesture/motion input such as waving, tapping, clapping, etc., and provide light and/or haptic output (e.g., feedback) via the wearable device that matches the frequency and intensity of the user's gesture/motion input. In an embodiment described herein, such a wearable device may be equipped with: at least one sensor (such as a accelerometer, a gyrometer, and/or a magnetometer), a processor subsystem for gesture pattern recognition and at least one feedback element (such as an LED and/or haptic motor) for providing responsive feedback.

As noted above, many wearable device systems merely provide non-adjustable, pre-determined light and haptic patterns to give system feedback to users. For example, if a wearable device is configured to flash one LED light when it registers a double-tap (e.g., via an accelerometer of the wearable device), which is simply two single taps received sufficiently close together in time, the system won't give any feedback for false negatives such as a single tap or two single taps separated in time by more than a threshold amount. In such a situation the user is left without any feedback at all. A more intuitive, natural, and engaging mechanism would allow users to interact with wearable devices by using the patterns of natural gestures as a basis for responsive feedback. In an embodiment described herein, adaptive light feedback is used to flash one LED light flash if the wearable device registers a single tap, and two light flashes if the wearable device registers a double-tap, giving the user an intuitive and responsive feedback that matches the pattern of the user's gestures. In the case of the two single taps separated in time by more than a threshold amount, the LED light will flash once after the threshold amount of time has passed from receiving the first tap, letting the user know that only one tap was received and the user should try again if the user intended to perform a double-tap gesture.

Systems and methods described herein provide a wearable electronic device with motion sensing capabilities such that user of the wearable device may express their intentions to the device by performing a physical gesture (e.g., a movement in the air) while wearing the device. The gestures may take the form of a physical motion the user performs while wearing the wearable device, such as waving her hand, or it may take the form of a user tapping the wearable device which may be detected using an accelerometer. In an embodiment described herein, the general process for generating interactive feedback based on detected gestures is as follows: the user performs a gesture (e.g., wave, tap, shake etc.); sensors (e.g., an accelerometer, gyrometer, and/or magnetometer) of the wearable device generate sensor data through detection of changing values; a gesture detection circuit of the wearable device processes the sensor data and detects a gesture based on a pattern of the sensor data; the gesture detection circuit confirms a state change from a first state (e.g., ‘no movement’) to a second state (‘wave’) based on the detected gesture; the gesture detection circuit then determines (using the sensor data) a pattern of the detected gesture by determining a number of times the gesture is performed during a period of time or an amplitude of the gesture in space. A processor subsystem of the wearable device calculates a feedback pattern and feedback intensity based on the detected gesture (e.g., wave) and/or the determined pattern of the gesture; and then the user receives feedback (via a feedback element such as an LED) according to the calculated feedback pattern and feedback intensity.

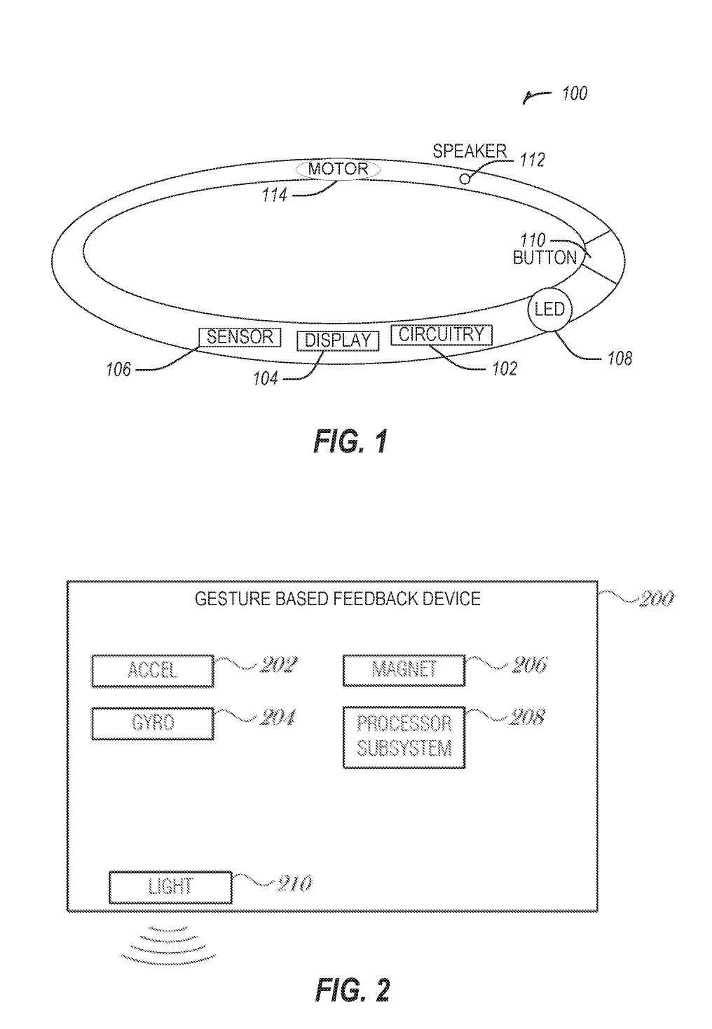

FIG. 1 illustrates an example wearable electronic device 100 in accordance with some embodiments. The wearable device 100 may include circuitry 102 such as a processor subsystem for detecting gestures of a user of the wearable device 100. In the example, the wearable device 100 includes an LED 108 for providing visual feedback to the user. The LED 108 may comprise a plurality of LEDs for providing a larger variety of feedback patterns. The wearable device 100 may also include one or more of: a display 104 for providing visual feedback to the user, a speaker 112 to provide audio feedback to the user, and a motor 114 to provide haptic feedback to the user. The example wearable device 100 also includes interfaces for receiving input from the user such as button 110 (e.g., a hardware button) or display 104 in the form of a touchscreen display. The example wearable device 100 includes at least one sensor 106 to detect values (e.g., acceleration, tilt, orientation, etc.) associated with a movement (e.g., gesture) of the user. The circuitry 102 may be used to determine that a recognized gesture (e.g., clapping or waving) has been made by the user of wearable device 100. The circuitry 102 may detect that the gesture has been performed by using data (e.g., recognizing data patterns) from the at least one sensor 106. In response to detecting that the gesture has been performed, the circuitry 102 may instruct any of the feedback elements (e.g., display 104, LED 108, speaker 112 or motor 114) of wearable device 100 to provide feedback. The feedback element may provide the feedback according to a feedback pattern and feedback intensity that are based on a pattern (e.g., number of repetitions per time period), of the detected gesture of the user, that is determined by the circuitry 102.

In example embodiments, the wearable device 100 may generate feedback including displaying light using the LED 108 or displaying video or an image using the display 104, sound using the speaker 112, or haptic feedback using motor 114. The at least one sensor 106 may be used to take a series of measurements at the wearable device 100. The series of measurements may be used to detect that a gesture has been made using the wearable device 100 (e.g., detect that the user is waving based on a pattern of the measurements) and also to determine a pattern of the gesture (e.g., detect that the wave is being repeated once every two seconds based on another pattern of the measurements). Furthermore, the detected gesture (and the associated determined gesture pattern) may be compared, using the circuitry 102, to an association table including a set of gestures (and/or gesture patterns) and a corresponding set of feedback patterns (and/or feedback intensities) to determine the feedback pattern and the feedback intensity for providing feedback via a feedback element of the wearable device 100. In this way the feedback pattern may be based on the detected gesture and/or the determined pattern of the gesture and the same goes for the feedback intensity. For example, the feedback intensity may be based on the detected gesture so that the default feedback intensity for one detected gesture (e.g., “fist pump”) may be greater than the default intensity for another detected gesture (e.g., “wave”) or it can be based on the determined pattern so that a rapidly repeating gesture results in a higher feedback intensity. In an embodiment, the feedback intensity may simply be a default intensity not based on the detected gesture or the determined pattern of the gesture, for example, if the association table includes no feedback intensity mapped to a particular detected gesture or pattern of the detected gesture.

In an example embodiment, the wearable device 100 may detect a user gesture such as taps from the user to initiate an action. For example, a single tap of the wearable device 100 may be used to connect with an external device, such as a mobile phone or host computer and a double-tap of the wearable device 100 may be used to place the wearable device 100 in a different state. The wearable device 100 may provide responsive feedback to the user's taps by mimicking the pattern of the user gesture with a feedback pattern of a feedback element of the wearable device 100. For example, by responding to a single tap with one flash of LED 108 and by responding to a double-tap with two flashes of LED 108 so that the user is confident that the wearable device 100 has initiated the action that the user intended.

FIG. 2 is a block diagram illustrating a gesture based feedback device 200, according to an embodiment. The gesture based feedback device 200 may be in the form of a wearable device (e.g., wearable device 100) or alternatively in the form of a mobile device (e.g., a smartphone, personal digital assistant, electronic baton, or the like) held by a user. The gesture based feedback device 200 is capable of capturing motion data using sensors that may include an accelerometer 202, a gyrometer 204, and/or a magnetometer 206. The gesture based feedback device 200 includes a processor subsystem 208 that accesses motion data from the sensors 202, 204, 206 and performs pattern recognition on the data. The recognized data patterns may be used by processor subsystem 208 to detect that a gesture has been performed by a user of gesture based feedback device 200. The processor subsystem 208 also accesses motion data from the sensors 202, 204, 206 that indicates a speed, amplitude and/or acceleration of the gesture performed. Using at least one of these parameters (speed, amplitude and acceleration), the processor subsystem 208 may determine a pattern of the detected gesture (e.g., how often does the gesture repeat itself in a time period). In response to ascertaining that the detected gesture has been performed according to the determined pattern of the gesture, the processor subsystem 208 may instruct a feedback element (e.g., light 210) of gesture based feedback device 200 to provide feedback with a feedback pattern of flashes and feedback intensity of illumination that are determined based on the detected gesture and the determined pattern of the gesture.

In example embodiments, the gesture based feedback device 200 may generate feedback using light 210 with a feedback pattern and feedback intensity that is determined by comparing, using the processor subsystem 208, the detected gesture and the determined pattern of the gesture to an association table including a set of gestures (and/or gesture patterns) mapped to a corresponding set of feedback patterns and/or feedback intensities.

In an example embodiment, gesture based feedback device 200 may use the accelerometer 202 to detect taps from a user anywhere on the feedback device 200. The gesture based feedback device 200 may also provide responsive feedback, as described above, with respect to a pattern of taps (e.g., how many taps in a time period) received from the user. For example, by responding to the pattern of taps with feedback having a feedback pattern that mimics the pattern of the received taps as explained above with respect to FIG. 1.

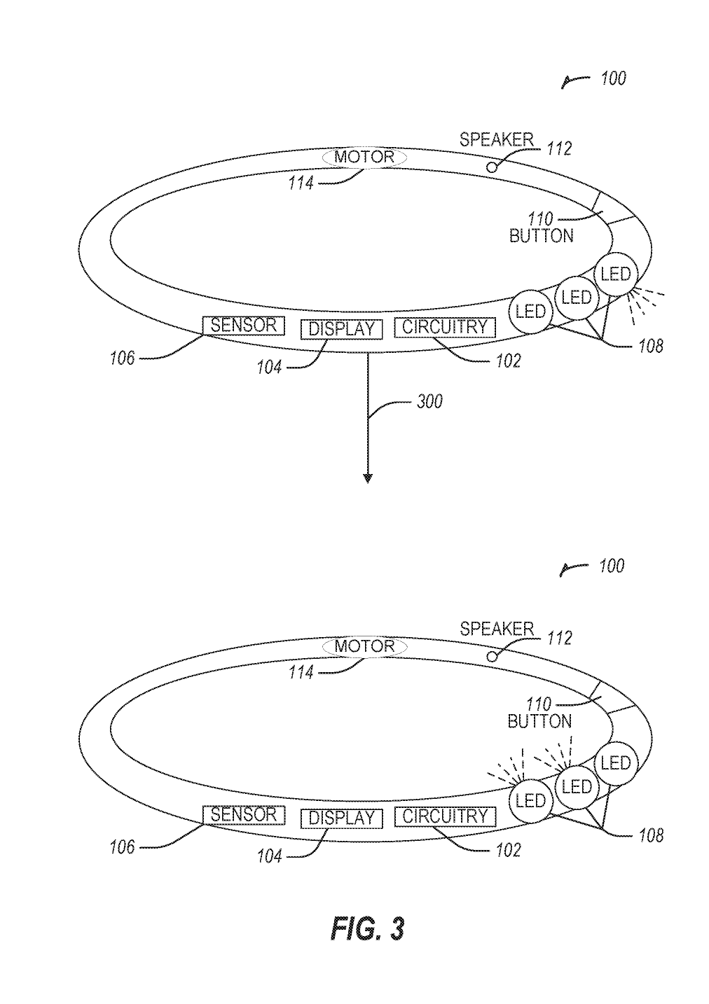

FIG. 3 is a use case diagram of an example wearable electronic device 100 upon which one or more embodiments may be implemented. As described above with respect to FIG. 1, the wearable device 100 may include circuitry 102 (such as processor subsystem 208 of FIG. 2) for detecting gestures of a user of the wearable device 100. In the example of FIG. 3, the wearable device 100 includes a plurality (e.g., 3) of LEDs 108 for providing visual feedback to the user according to a variety of feedback patterns. As noted above, a wearable device may be configured to flash one LED light flash when it registers a double-tap (e.g., via a sensor 106 of the wearable device), however, the wearable device may not give any feedback for false negatives such as a single received tap (e.g., within a specified time period). Also as explained above, a more intuitive and responsive mechanism would provide feedback to a user that indicated to the user that the wearable device had recognized a pattern of the user gesture. As shown at the top of FIG. 3, the wearable device 100 has detected a single tap from the user (instead of the double-tap intended by the user) and the detected user gesture (e.g., a tap) and determined pattern of the gesture (e.g., only detected once in a time period) is used to provide responsive feedback with a feedback pattern that mimics the pattern of the gesture by providing a single flash from a single LED of the multiple LEDs 108 at the end of the time period (e.g., before a late second tap is received). The feedback may also be provided via another feedback element (e.g., display 104, speaker 112 or motor 114) of wearable device 100. The user may realize, based on the single flash feedback, that a double-tap will not be registered by the wearable device 100 and proceed to try again as indicated by arrow 300.

At the bottom of FIG. 3, the wearable device 100 has now detected a double-tap from the user and the pattern of the user gesture (e.g., two taps detected in a time period) is used to provide responsive feedback with a feedback pattern that mimics the pattern of the user input by providing flashes from two of the LEDs of the multiple LEDs 108 at the end of the time period. Alternatively, two successive flashes from a single LED of the multiple LEDs 108 may be provided separated by the same amount of time as the two detected taps from the user. As noted above, the feedback may also be provided via another feedback element (e.g., display 104, speaker 112 or motor 114) of wearable device 100 according to the feedback pattern that mimics the pattern of the user's gesture.

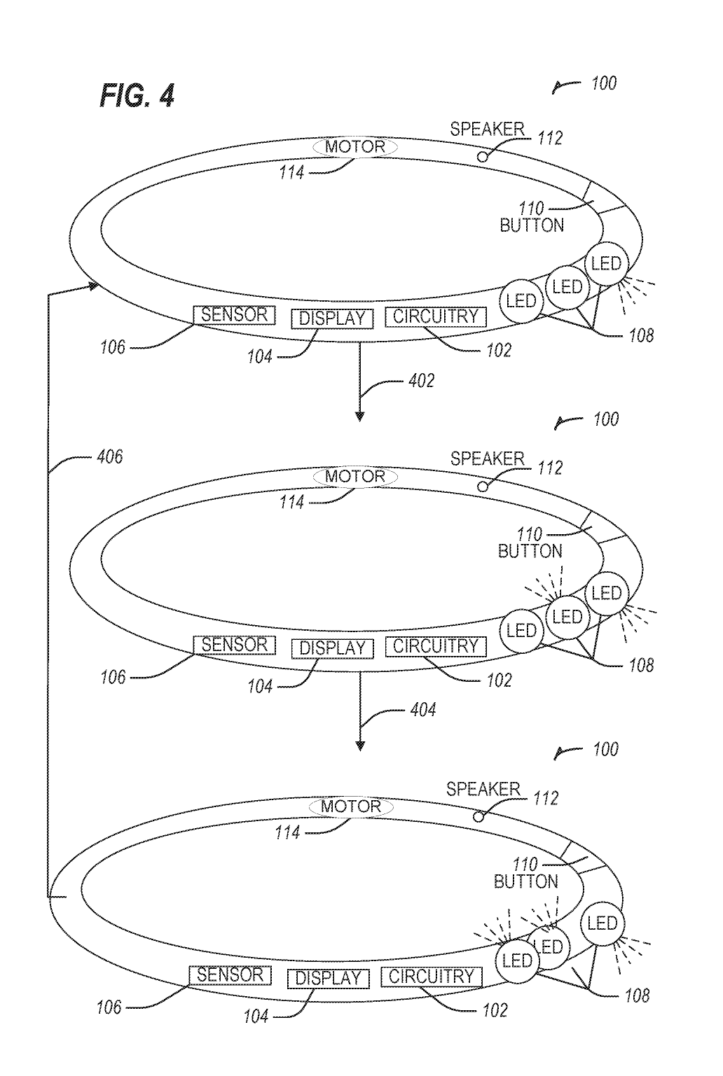

FIG. 4 is a use case diagram of an example wearable electronic device 100 upon which one or more embodiments may be implemented. As described above with respect to FIG. 1, the wearable device 100 may include circuitry 102 (such as processor subsystem 208 of FIG. 2) for detecting gestures of a user of the wearable device 100. In the example of FIG. 4, the wearable device 100 includes a plurality (e.g., 3) of LEDs 108 for providing visual feedback to the user according to a variety of feedback patterns. In the present example, the wearable device 100 detects hand motions of a user and provides corresponding light feedback using the LEDs 108. For example, LED bracelets are widely used for concerts and shows so that a group of people in the same space wearing such LED bracelets may generate a joint light effect that becomes part of the experience of the concert or show. The at least one sensor 106 and the circuitry 102 of the wearable device 100 may detect gestures of the user the wearable device 100. When the user puts the wearable device 100 on at a concert and starts moving, the wearable device 100 will analyze data from the at least one sensor 106 (e.g., detect a gesture and determine a gesture pattern) and customize the light output of the LEDs 108 based on the gesture and the pattern of the gesture. For example, if the user gesture is identified as a “wave” of the user's hand and the pattern of the wave is a slowly repeating pattern according to the music at the concert, the light output of the LEDs 108 will match the frequency of the user's wave pattern, slowly fading in and out by flashing different combinations of the LEDs 108. The luminous intensity of the flashes of the LEDs 108 may also be varied over a range of intensities based on the user's detected wave pattern. If the user changes the movement to a fist pump (e.g., new detected gesture) when there's faster music at the concert, the frequency and intensity of the feedback from the LEDs 108 will also change (e.g., repeated pulse of 250 ms on and off) to match the user's current hand gesture and gesture pattern.

In the present example, the feedback pattern begins at the top of FIG. 4 with a single flash of an LED 108 at a first feedback intensity corresponding to an initial motion of the detected “wave” of the user's hand. The feedback pattern continues as indicated by arrow 402 with a single flash of two LEDs of the LEDs 108 at a second feedback intensity (which could be the same as the first feedback intensity) corresponding to the continuing motion of the detected “wave” of the user's hand. The feedback pattern finalizes as indicated by arrow 404 with a single flash of all three LEDs of the LEDs 108 at a third feedback intensity (which could be the same as either of the previous feedback intensities) corresponding to the final motion of the detected “wave” of the user's hand. For example, if the waving motion accelerates towards the end of the wave gesture, the feedback intensity could be greater towards the end of the gesture. The detection of a repetition of the initial motion of the “wave” of the user's hand indicates that a final motion of the detected “wave” gesture has just occurred (e.g., immediately prior to detection of the repetition of the initial motion). In other words a repetition of the wave gesture is determined and the feedback pattern of the LEDs 108 returns to that of the top of FIG. 4 (e.g., corresponding to the initial motion of the wave) as indicated by arrow 406. The speed at which the feedback pattern repeats and the intensity of the feedback at each step of the feedback pattern may both be responsive to the detected user gesture and the determined pattern of the detected user gesture (e.g., how often does the gesture repeat during a time period).

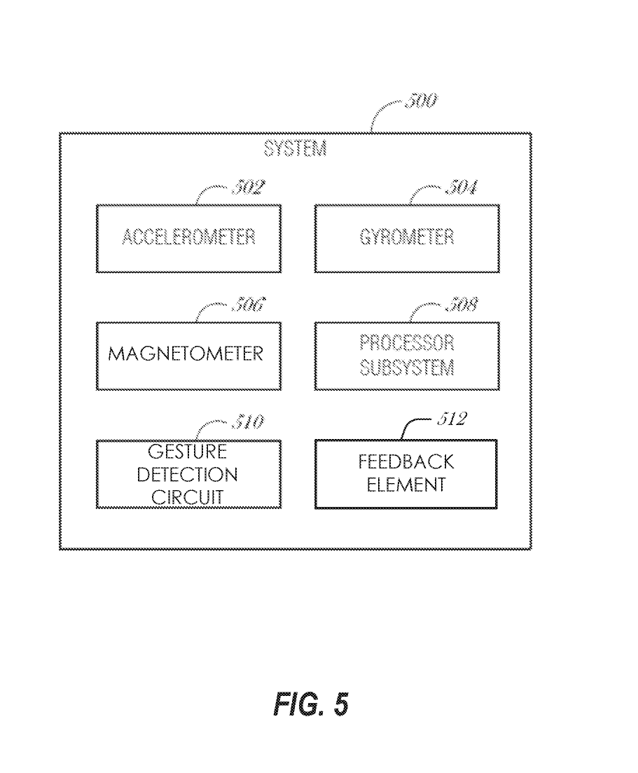

FIG. 5 is a block diagram illustrating system 500 for providing feedback based on detected gestures, according to an embodiment. The system 500 may include an accelerometer 502, a gyrometer 504, a magnetometer 506, a processor subsystem 508, a gesture detection circuit 510, and at least one feedback element 512, such as the LED 108 of FIG. 1.

The gesture detection circuit 510 may be configured to detect a gesture performed by a user of the system based on data from the accelerometer 502, the gyrometer 504 and/or the magnetometer 506. Gesture detection may be based on pattern recognition that uses a machine learning technique to classify recognized patterns in the data into a gesture.

The term “gesture” as used herein describes a movement in space by a person moving their arm, hands, fingers, or some combination of these on one or both arms. The gesture may also be performed with one's legs, or combinations of arms, body, and legs. The term gesture as used herein includes gestures performed in the air and tapping gestures that are performed on a wearable device capable of detecting such tapping gestures (e.g., using an accelerometer). In an embodiment, the gesture comprises a user tapping an element of the system, raising a hand, waving a hand or clapping hands.

In an embodiment, to detect the gesture, the gesture detection circuit 510 is to determine a speed, an orientation, a tilt or an acceleration of the user based on data from the accelerometer 502, the gyrometer 504 and/or the magnetometer 506.

The gesture detection circuit 510 may be further configured to determine a pattern of the detected gesture. Determining the pattern of the gesture may include analyzing the gesture in the time domain to determine a number of instances of the gesture that are performed in a given period of time (e.g., how often does the gesture repeat). The pattern recognition may also include analyzing the gesture in the space domain to determine an amplitude of the gesture (e.g., a larger waving of the hands versus a smaller waving). Determining the pattern of the gesture may also include analyzing the gesture in the both the space and time domains to determine a number of instances of a sequence of amplitudes of the gesture (e.g., a larger hand waving followed by two smaller hand wavings) that are performed (e.g., repeated) in a given period of time.

In an embodiment, to determine the pattern of the gesture, the gesture detection circuit 510 is to determine a pattern of the gesture, e.g., based on pattern recognition that uses a machine learning technique to classify recognized patterns in the sensor data associated with a detected gesture into a pattern for the detected gesture. In other words, the pattern of the gesture is a metapattern comprising a pattern of the recognized patterns of sensor data including the sensor data that formed the basis for the detection of the gesture. For example, in the time domain, the pattern may be based on a number of times the gesture is repeated in a period of time. The period of time may vary from a relatively short period of time, such as one second to a relatively long period of time, such as ten seconds. For example, the number of claps performed in a five second period may be measured and then a number of claps per second may be determined to describe the pattern of the gesture. The corresponding feedback pattern and/or intensity (e.g., in an association table as described herein) may be based on a predetermined range of claps per second.

In an embodiment, to determine the feedback pattern and/or the feedback intensity, the processor subsystem 508 is to perform a lookup on an association table, the association table including a set of gestures and/or associated patterns of gestures (e.g., a “wave” gesture and associated time and space domain patterns such as “fast waving” or “wide waving”) mapped to a corresponding set of feedback patterns and/or feedback intensities. Accordingly, the association table allows the processor subsystem 508 to determine a feedback pattern and/or feedback intensity for a detected gesture, a determined pattern of the gesture or a combination of the detected gesture and the pattern of the gesture. The association table may be uploaded to the system before or during an event (e.g., while a football game is being played). As such, using the association table, the recognized gestures/gesture patterns and the feedback patterns/intensities that they are mapped to may be dynamically altered throughout the event.

In an embodiment, to determine the feedback intensity, the processor subsystem 508 is to scale the feedback intensity over a range based on the pattern of the gesture. For example, the range may be based on empirical data of gesture amplitudes for different gestures. When clapping, a slow clap may be set as being approximately one clap per second, whereas a fast clap may be set as approximately ten claps per second. A minimum feedback intensity may be set to a minimum value that will be perceived by the user. The minimum feedback intensity may have some error protection built in to ensure that feedback is perceived by the user. The maximum feedback intensity may be based on available battery capabilities and/or available capabilities of he at least one feedback element 512. Once the minimum and maximum feedback intensities and gesture amplitudes are known, a one-to-one mapping may be determined and used for scaling the feedback intensity over a range based on the pattern of the gesture.

The at least one feedback element 512 may comprise an LED or a haptic motor. As noted above, the at least one feedback element 512 may also comprise a display or a speaker for providing image and audio feedback.

In an embodiment, to provide feedback according to the feedback pattern, the at least one feedback element 512 is to provide feedback with a feedback pattern that mimics the pattern of the gesture. As noted above, the system may respond to a single tap from a user with one flash of light, one beep of sound or one haptic buzz from the at least one feedback element 512 and may respond to a double-tap from the user with two flashes of light, two beeps of sound or two haptic buzzes.

In an embodiment, to provide feedback according to the feedback pattern, the at least one feedback element 512 is to illuminate a light of the system (e.g., LED 108) at a color correlated to the feedback pattern. The color of the illumination may be correlated to the pattern of the gesture based on the available colors of the lights in the system 500.

In an embodiment, to provide feedback according to the feedback intensity, the at least one feedback element 512 is to illuminate a light of the system (e.g., LED 108) at a luminous intensity correlated to the feedback intensity. Luminous intensity may be correlated to the feedback intensity based on a minimum and maximum available intensity of the lights in the system 500.

In an embodiment, to provide feedback according to the feedback pattern, the at least one feedback element 512 is to illuminate each of a plurality of lights of the system (e.g., LEDs 108) in a sequence correlated to the feedback pattern. The sequence of illumination may be correlated to the pattern of the gesture based on the available number of lights in the system 500).

In an embodiment, to provide feedback according to the feedback intensity, the at least one feedback element 512 is to operate a motor of the system (e.g., motor 114) at a speed correlated to the feedback intensity. Motor speed may be correlated to the feedback intensity based on a minimum and maximum speed of the motors in the system 500.

In an embodiment, the system 500 is a wearable device, such as a smart ring, a smart bracelet, smart goggles, etc. In an embodiment, the system 500 is a wrist-worn wearable device such as a smart watch.

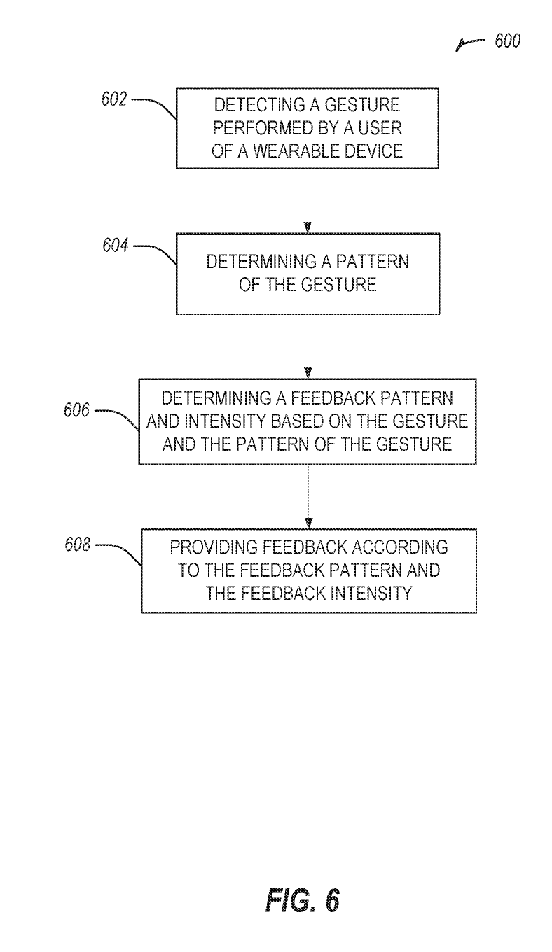

FIG. 6 is a flowchart illustrating a method 600 for providing feedback based on detected gestures, according to an embodiment.

At block 602, a gesture performed by a user of a wearable device is detected by the wearable device. In an embodiment, the gesture comprises: tapping an element of the wearable device, raising a hand, waving a hand or clapping hands. In an embodiment, the wearable device is a wrist-worn device. In an embodiment, the detecting the gesture comprises determining a speed, an orientation, a tilt or an acceleration of the user.

At block 604, a pattern of the gesture is determined. Determining the pattern of the gesture may include analyzing the gesture in the time domain to determine a number of instances of the gesture that are performed in a given period of time (e.g., how often does the gesture repeat) and/or analyzing the gesture in the space domain to determine an amplitude of the gesture (e.g., a larger waving of the hands versus a smaller waving).

At block 606, a feedback pattern and a feedback intensity is determined based on the gesture and the pattern of the gesture. In an embodiment, determining the feedback pattern and a feedback intensity comprises performing a lookup on an association table, the association table including a set of gestures and/or gesture patterns and a corresponding set of mapped feedback patterns and/or feedback intensities. In an embodiment, determining a feedback intensity comprises scaling the feedback intensity over a range based on the pattern of the gesture.

At block 608, feedback is provided according to the feedback pattern and the feedback intensity. In an embodiment, providing feedback according to the feedback pattern comprises providing feedback with a feedback pattern that mimics the pattern of the gesture.

In an embodiment, providing feedback according to the feedback pattern comprises illuminating a light of the system at a color correlated to the feedback pattern.

In an embodiment, providing feedback according to the feedback intensity comprises illuminating a light of the wearable device at a luminous intensity correlated to the feedback intensity.

In an embodiment, providing feedback according to the feedback pattern comprises illuminating each of a plurality of lights of the system in a sequence correlated to the feedback pattern.

In an embodiment, providing feedback according to the feedback intensity comprises operating a motor of the system at a speed correlated to the feedback intensity.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

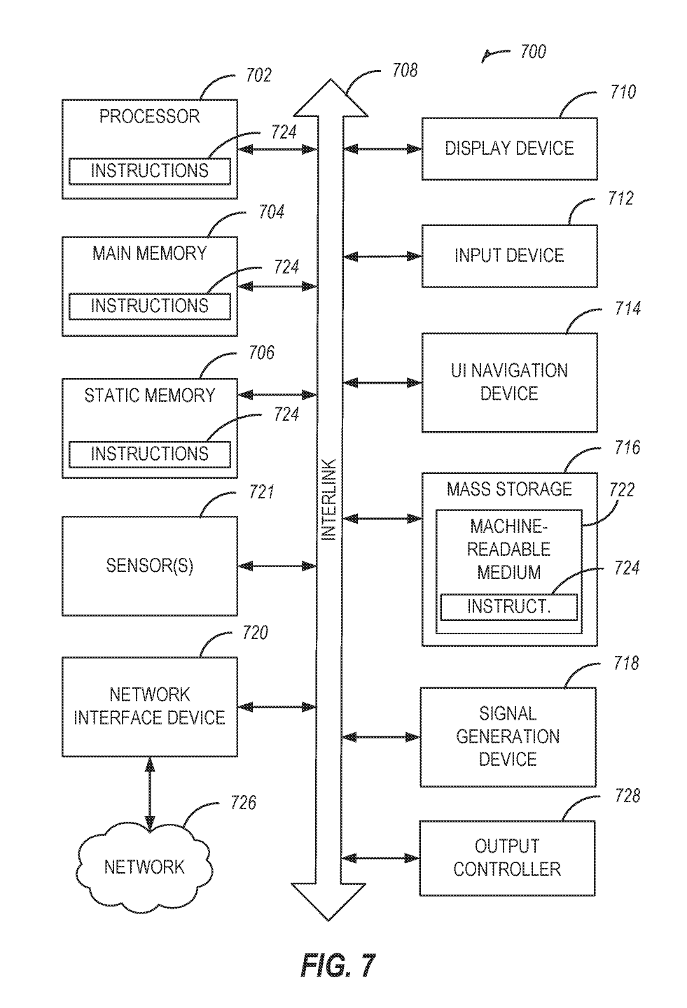

FIG. 7 is a block diagram illustrating a machine in the example form of a computer system 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, gyrometer, magnetometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is a system for providing feedback based on detected gestures, the system comprising: a sensor; a gesture detection circuit to: detect a gesture performed by a user of the system based on data from the sensor; and determine a pattern of the gesture; a processor subsystem to determine a feedback pattern and a feedback intensity based on the gesture and the pattern of the gesture; and a feedback element to provide feedback according to the feedback pattern and the feedback intensity.

In Example 2, the subject matter of Example 1 optionally includes wherein the sensor comprises an accelerometer, a gyrometer or a magnetometer.

In Example 3, the subject matter of any one or more of Examples 1-2 optionally include wherein the gesture comprises tapping an element of the system, raising a hand, waving a hand or clapping hands.

In Example 4, the subject matter of any one or more of Examples 1-3 optionally include wherein to detect the gesture, the gesture detection circuit is to determine a speed, a tilt, an orientation or an acceleration of the user.

In Example 5, the subject matter of any one or more of Examples 1-4 optionally include wherein to determine the pattern of the gesture, the gesture detection circuit is to determine a number of times the gesture is performed in a period of time or a spatial amplitude of the gesture.

In Example 6, the subject matter of any one or more of Examples 1-5 optionally include wherein to determine the feedback pattern or the feedback intensity, the processor subsystem is to perform a lookup on an association table, the association table including a set of gestures and/or patterns of gestures and a corresponding set of feedback patterns and/or feedback intensities.

In Example 7, the subject matter of any one or more of Examples 1-6 optionally include wherein to determine the feedback intensity, the processor subsystem is to scale the feedback intensity over a range based on the pattern of the gesture.

In Example 8, the subject matter of any one or more of Examples 1-7 optionally include wherein the feedback element comprises an LED or a haptic motor.

In Example 9, the subject matter of any one or more of Examples 1-8 optionally include wherein to provide feedback according to the feedback pattern, the feedback element is to provide feedback with a feedback pattern that mimics the pattern of the gesture.

In Example 10, the subject matter of any one or more of Examples 1-9 optionally include wherein to provide feedback according to the feedback pattern, the feedback element is to illuminate a light of the system at a color correlated to the feedback pattern.

In Example 11, the subject matter of any one or more of Examples 1-10 optionally include wherein to provide feedback according to the feedback intensity, the feedback element is to illuminate a light of the system at a luminous intensity correlated to the feedback intensity.

In Example 12, the subject matter of any one or more of Examples 1-11 optionally include wherein to provide feedback according to the feedback pattern, the feedback element is to illuminate each of a plurality of lights of the system in a sequence correlated to the feedback pattern.

In Example 13, the subject matter of any one or more of Examples 1-12 optionally include wherein to provide feedback according to the feedback intensity, the feedback element is to operate a motor of the system at a speed correlated to the feedback intensity.

In Example 14, the subject matter of any one or more of Examples 1-13 optionally include wherein the system comprises a wearable device.

In Example 15, the subject matter of Example 14 optionally includes wherein the wearable device is a wrist-worn device.

Example 16 is a method for providing feedback based on detected gestures, the method comprising: detecting, at a wearable device, a gesture performed by a user of the wearable device; determining a pattern of the gesture; determining a feedback pattern and a feedback intensity based on the gesture and the pattern of the gesture; and providing feedback according to the feedback pattern and the feedback intensity.

In Example 17, the subject matter of Example 16 optionally includes wherein the wearable device comprises an accelerometer, a gyrometer or a magnetometer.

In Example 18, the subject matter of any one or more of Examples 16-17 optionally include wherein the gesture comprises tapping an element of the wearable device, raising a hand, waving a hand or clapping hands.

In Example 19, the subject matter of any one or more of Examples 16-18 optionally include wherein detecting the gesture comprises determining a speed, a tilt, an orientation or an acceleration of the user.

In Example 20, the subject matter of any one or more of Examples 16-19 optionally include wherein determining the pattern of the gesture comprises determining a number of times the gesture is performed in a period of time or a spatial amplitude of the gesture.

In Example 21, the subject matter of any one or more of Examples 16-20 optionally include wherein determining the feedback pattern and/or the feedback intensity comprises performing a lookup on an association table, the association table including a set of gestures and/or patterns of gestures and a corresponding set of feedback patterns and/or feedback intensities.

In Example 22, the subject matter of any one or more of Examples 16-21 optionally include wherein determining the feedback intensity comprises scaling the feedback intensity over a range based on the pattern of the gesture.

In Example 23, the subject matter of any one or more of Examples 16-22 optionally include wherein providing feedback according to the feedback pattern comprises providing feedback with a feedback pattern that mimics the pattern of the gesture.

In Example 24, the subject matter of any one or more of Examples 16-23 optionally include wherein providing feedback according to the feedback pattern and the feedback intensity comprises providing feedback via an LED or a haptic motor.

In Example 25, the subject matter of any one or more of Examples 16-24 optionally include wherein providing feedback according to the feedback pattern comprises illuminating a light of the wearable device at a color correlated to the feedback pattern.

In Example 26, the subject matter of any one or more of Examples 16-25 optionally include wherein providing feedback according to the feedback intensity comprises illuminating a light of the wearable device at a luminous intensity correlated to the feedback intensity.

In Example 27, the subject matter of any one or more of Examples 16-26 optionally include wherein providing feedback according to the feedback pattern comprises illuminating each of a plurality of lights of the wearable device in a sequence correlated to the feedback pattern.

In Example 28, the subject matter of any one or more of Examples 16-27 optionally include wherein providing feedback according to the feedback intensity comprises operating a motor of the wearable device at a speed correlated to the feedback intensity.

In Example 29, the subject matter of any one or more of Examples 16-28 optionally include wherein the wearable device is a wrist-worn device.

Example 30 is at least one machine-readable medium including instructions, which when executed by a machine, cause the machine to perform operations of any of the methods of Examples 16-29.

Example 31 is an apparatus comprising means for performing any of the methods of Examples 16-29.

Example 32 is an apparatus for providing feedback based on detected gestures, the apparatus comprising: means for detecting, at a wearable device, a gesture performed by a user of the wearable device; means for determining a pattern of the gesture; means for determining a feedback pattern and a feedback intensity based on the gesture and the pattern of the gesture; and means for providing feedback according to the feedback pattern and the feedback intensity.

In Example 33, the subject matter of Example 32 optionally includes wherein the wearable device comprises an accelerometer, a gyrometer or a magnetometer.

In Example 34, the subject matter of any one or more of Examples 32-33 optionally include wherein the gesture comprises tapping an element of the wearable device, raising a hand, waving a hand or clapping hands.

In Example 35, the subject matter of any one or more of Examples 32-34 optionally include wherein the means for detecting the gesture comprise means for determining a speed, a tilt, an orientation or an acceleration of the user.

In Example 36, the subject matter of any one or more of Examples 32-35 optionally include wherein the means for determining the pattern of the gesture comprise means for determining a number of times the gesture is performed in a period of time or a spatial amplitude of the gesture.

In Example 37, the subject matter of any one or more of Examples 32-36 optionally include wherein the means for determining the feedback pattern and/or the feedback intensity comprise means for performing a lookup on an association table, the association table including a set of gestures and/or patterns of gestures and a corresponding set of feedback patterns and/or feedback intensities.

In Example 38, the subject matter of any one or more of Examples 32-37 optionally include wherein the means for determining the feedback intensity comprise means for scaling the feedback intensity over a range based on the pattern of the gesture.

In Example 39, the subject matter of any one or more of Examples 32-38 optionally include wherein the means for providing feedback according to the feedback pattern comprise means for providing feedback with a feedback pattern that mimics the pattern of the gesture.

In Example 40, the subject matter of any one or more of Examples 32-39 optionally include wherein the means for providing feedback according to the feedback pattern and the feedback intensity comprise an LED or a haptic motor.

In Example 41, the subject matter of any one or more of Examples 32-40 optionally include wherein the means for providing feedback according to the feedback pattern comprise means for illuminating a light of the wearable device at a color correlated to the feedback pattern.

In Example 42, the subject matter of any one or more of Examples 32-41 optionally include wherein the means for providing feedback according to the feedback intensity comprise means for illuminating a light of the wearable device at a luminous intensity correlated to the feedback intensity.

In Example 43, the subject matter of any one or more of Examples 32-42 optionally include wherein the means for providing feedback according to the feedback pattern comprise means for illuminating each of a plurality of lights of the wearable device in a sequence correlated to the feedback pattern.

In Example 44, the subject matter of any one or more of Examples 32-43 optionally include wherein the means for providing feedback according to the feedback intensity comprise means for operating a motor of the wearable device at a speed correlated to the feedback intensity.

In Example 45, the subject matter of any one or more of Examples 32-44 optionally include wherein the wearable device is a wrist-worn device.

Example 46 is a system for providing feedback based on detected gestures, the system comprising: at least one processor; and a memory including instructions, which when executed by the at least one processor, cause the system to: detect a gesture performed by a user of the system based on data from a sensor; determine a pattern of the gesture; determine a feedback pattern and a feedback intensity based on the gesture and the pattern of the gesture; and provide feedback according to the feedback pattern and the feedback intensity.

In Example 47, the subject matter of Example 46 optionally includes wherein the sensor comprises an accelerometer, a gyrometer or a magnetometer.

In Example 48, the subject matter of any one or more of Examples 46-47 optionally include wherein the gesture comprises tapping an element of the system, raising a hand, waving a hand or clapping hands.

In Example 49, the subject matter of any one or more of Examples 46-48 optionally include wherein the instructions for detecting the gesture comprise instructions for determining a speed, a tilt, an orientation or an acceleration of the user.

In Example 50, the subject matter of any one or more of Examples 46-49 optionally include wherein the instructions for determining the pattern of the gesture comprise instructions for determining a number of times the gesture is performed in a period of time or a spatial amplitude of the gesture.

In Example 51, the subject matter of any one or more of Examples 46-50 optionally include wherein the instructions for determining the feedback pattern and/or the feedback intensity comprise instructions for performing a lookup on an association table, the association table including a set of gestures and/or patterns of gestures and a corresponding set of feedback patterns and/or feedback intensities.

In Example 52, the subject matter of any one or more of Examples 46-51 optionally include wherein the instructions for determining the feedback intensity comprise instructions for scaling the feedback intensity over a range based on the pattern of the gesture.

In Example 53, the subject matter of any one or more of Examples 46-52 optionally include wherein the instructions for providing feedback according to the feedback pattern comprise instructions for providing feedback with a feedback pattern that mimics the pattern of the gesture.

In Example 54, the subject matter of any one or more of Examples 46-53 optionally include wherein the instructions for providing feedback according to the feedback pattern and the feedback intensity comprise instructions to provide feedback via an LED or a haptic motor.

In Example 55, the subject matter of any one or more of Examples 46-54 optionally include wherein the instructions for providing feedback according to the feedback pattern comprise instructions for illuminating a light of the system at a color correlated to the feedback pattern.

In Example 56, the subject matter of any one or more of Examples 46-55 optionally include wherein the instructions for providing feedback according to the feedback intensity comprise instructions for illuminating a light of the wearable device at a luminous intensity correlated to the feedback intensity.

In Example 57, the subject matter of any one or more of Examples 46-56 optionally include wherein the instructions for providing feedback according to the feedback pattern comprise instructions for illuminating each of a plurality of lights of the system in a sequence correlated to the feedback pattern.

In Example 58, the subject matter of any one or more of Examples 46-57 optionally include wherein the instructions for providing feedback according to the feedback intensity comprise instructions for operating a motor of the system at a speed correlated to the feedback intensity.

In Example 59, the subject matter of any one or more of Examples 46-58 optionally include wherein the system comprises a wearable device.

In Example 60, the subject matter of Example 59 optionally includes wherein the wearable device is a wrist-worn device.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “a and/or b” is used to denote “a” or “b” or “a and b”. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second.” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for providing feedback based on detected gestures, the system comprising:
a sensor;
a gesture detection circuit to:
detect a gesture performed by a user of the system based on data from the sensor; and
determine a pattern of the gesture;
a processor subsystem to determine a feedback pattern and a feedback intensity based on the gesture and the pattern of the gesture; and
a feedback element to provide feedback according to the feedback pattern and the feedback intensity.

2. The system of claim 1, wherein the sensor comprises an accelerometer, a gyrometer or a magnetometer.

3. The system of claim 1, wherein the gesture comprises tapping an element of the system, raising a hand, waving a hand or clapping hands.

4. The system of claim 1, wherein to detect the gesture, the gesture detection circuit is to determine a speed, a tilt, an orientation or an acceleration of the user.

5. The system of claim 1, wherein to determine the pattern of the gesture, the gesture detection circuit is to determine a number of times the gesture is performed in a period of time or a spatial amplitude of the gesture.

6. The system of claim 1, wherein to determine the feedback pattern or the feedback intensity, the processor subsystem is to perform a lookup on an association table, the association table including a set of gestures and/or patterns of gestures and a corresponding set of feedback patterns and/or feedback intensities.

7. The system of claim 1, wherein to determine the feedback intensity, the processor subsystem is to scale the feedback intensity over a range based on the pattern of the gesture.

8. The system of claim 1, wherein the feedback element comprises an LED or a haptic motor.

9. The system of claim 1, wherein to provide feedback according to the feedback pattern, the feedback element is to provide feedback with a feedback pattern that mimics the pattern of the gesture.

10. The system of claim 1, wherein to provide feedback according to the feedback pattern, the feedback element is to illuminate a light of the system at a color correlated to the feedback pattern.

11. The system of claim 1, wherein to provide feedback according to the feedback intensity, the feedback element is to illuminate a light of the system at a luminous intensity correlated to the feedback intensity.

12. The system of claim 1, wherein to provide feedback according to the feedback pattern, the feedback element is to illuminate each of a plurality of lights of the system in a sequence correlated to the feedback pattern.

13. The system of claim 1, wherein to provide feedback according to the feedback intensity, the feedback element is to operate a motor of the system at a speed correlated to the feedback intensity.

14. The system of claim 1, wherein the system comprises a wearable device.

15. The system of claim 14, wherein the wearable device is a wrist-worn device.

16. A method for providing feedback based on detected gestures, the method comprising:
detecting, at a wearable device, a gesture performed by a user of the wearable device;
determining a pattern of the gesture;
determining a feedback pattern and a feedback intensity based on the gesture and the pattern of the gesture; and
providing feedback according to the feedback pattern and the feedback intensity.

17. The method of claim 16, wherein determining the pattern of the gesture comprises determining a number of times the gesture is performed in a period of time or a spatial amplitude of the gesture.

18. The method of claim 16, wherein determining the feedback pattern and/or the feedback intensity comprises performing a lookup on an association table, the association table including a set of gestures and/or patterns of gestures and a corresponding set of feedback patterns and/or feedback intensities.

19. The method of claim 16, wherein determining the feedback intensity comprises scaling the feedback intensity over a range based on the pattern of the gesture.

20. The method of claim 16, wherein providing feedback according to the feedback pattern comprises providing feedback with a feedback pattern that mimics the pattern of the gesture.

21. The method of claim 16, wherein providing feedback according to the feedback pattern comprises illuminating a light of the wearable device at a color correlated to the feedback pattern.

22. The method of claim 16, wherein providing feedback according to the feedback intensity comprises illuminating a light of the wearable device at a luminous intensity correlated to the feedback intensity.

23. At least one machine-readable medium including instructions, which when executed by a machine, cause the machine to:
detect, at a wearable device, a gesture performed by a user of the wearable device;
determine a pattern of the gesture;
determine a feedback pattern and a feedback intensity based on the gesture and the pattern of the gesture; and
provide feedback according to the feedback pattern and the feedback intensity.

24. The at least one machine-readable medium of claim 23, wherein the instructions to determine the feedback pattern and/or the feedback intensity comprises performing a lookup on an association table, the association table including a set of gestures and/or patterns of gestures and a corresponding set of feedback patterns and/or feedback intensities.

25. The at least one machine-readable medium of claim 23, wherein the instructions to determine the feedback intensity comprise instructions to scale the feedback intensity over a range based on the pattern of the gesture.
